(19) United States
(12) Patent Application Publication
(10) Pub. No.: US 2026/0238295 A1
(43) Pub. Date: Aug. 13, 2026

(54) SYSTEMS AND METHODS FOR EFFICIENT INFORMATION EXCHANGE BETWEEN UE AND gNB FOR CSI COMPRESSION

(71) Applicant: Mavenir Systems, Inc., Richardson, TX (US)

(72) Inventors: Jianying Liu, Beijing (CN); Fan Yang, Beijing (CN); Hong Zhou, Beijing (CN); Yuanlong Yang, Beijing (CN); Ting Du, Beijing (CN)

(73) Assignee: Mavenir Systems, Inc., Richardson, TX (US)

(21) Appl. No.: 19/639,503

(22) Filed: Apr. 6, 2026

Related U.S. Application Data
(63) Continuation of application No. PCT/CN2023/123252, filed on Oct. 7, 2023.

(51) Int. Cl. H04B 7/06; H04B 17/318; H04L 41/16

(52) U.S. Cl. CPC H04B 7/0626; H04B 17/328; H04L 41/16

(57) ABSTRACT

Systems and methods for employing legacy Channel State Information (CSI) compression and prediction or AI/ML based CSI compression and prediction.

### CROSS REFERENCE TO RELATED APPLICATIONS

This application claims priority to International Application No. PCT/CN2023/123252, filed on Oct. 7, 2023, the entirety of which is incorporated herein by reference.

### DESCRIPTION OF THE RELATED TECHNOLOGY

### Field of the Disclosure

The present disclosure relates to systems and methods for radio access networks. The present disclosure is related to the design of operation, administration and management of various network elements of 4G and 5G based mobile networks. The present disclosure relates to CSI enhancements in mobile networks.

### Description of the Related Art

Legacy CSI reporting is based on CSI-RS measurement. With the help of AI, UE report AI/ML-based CSI (channel state information) compression and prediction that can more accurately match a current wireless channel situation with based on training models. As a result, a base station can be better optimized dynamically, helping UE improve throughput and other key performance metrics.

### SUMMARY

Described are systems and methods for CSI feedback through AI/ML, including the air interface enhancement of the CSI feedback with enabling AI/ML-based algorithms. In implementations, enhancements include CSI enhancements for the gNB and UE.

In an implementation, described is technology for providing technical solutions for problems including:
a priority rule for CSI collision between legacy CSI and AI/ML-based CSI compression;
A fallback to legacy CSI from AI/ML-based CSI compression; and
A procedure of CSI prediction between gNB and UE.

Described are implementations for enhancements for an air-interface CSI feedback with enabling AI.

In an implementation, AI/ML-based CSI compression can be made more accurate and reliable as compared with legacy CSI. When AI/ML-based CSI compression (and prediction) has a conflict with legacy CSI, an AI/ML-based CSI compression (and prediction) can be configured to have a higher priority than legacy CSI; and for AI/ML-based CSI compression and prediction, AI/ML-based CSI carrying L1-RSRP or L1-SINR can have a higher priority than without carrying L1-RSRP or L1-SINR.

In an implementation when AI/ML-based CSI cannot work or handover, a UE needs to report legacy CSI for guaranteeing network performance. Described are implementations for AI/ML-based CSI compression and prediction fallback to legacy CSI. An in implementation, described are UE-initiate and gNB-initiate procedures.

In an implementation, CSI prediction can reduce overhead and improve accuracy. In an implementation, described is a CSI prediction procedure between UE and gNB for a UE-initiate and a gNB-initiate.

### BRIEF DESCRIPTION OF THE DRAWINGS

FIG. 1A shows a procedure of AI/ML-based CSI fallback compression (and prediction) to legacy CSI by gNB-initiate.

FIG. 1B shows the procedure of an AI/ML-based CSI fallback compression (and prediction) to legacy CSI by UE-initiate.

FIG. 2A shows a procedure of CSI prediction by gNB-initiate.

FIG. 2B shows a procedure of CSI prediction by UE-initiate.

FIG. 3 is a block diagram of a system architecture.

### DETAILED DESCRIPTION OF THE IMPLEMENTATIONS

Reference is made to Third Generation Partnership Project (3GPP) and the Internet Engineering Task Force (IETF) in accordance with embodiments of the present disclosure. The present disclosure employs abbreviations, terms and technology defined in accord with Third Generation Partnership Project (3GPP) and/or Internet Engineering Task Force (IETF) technology standards and papers, including the following standards and definitions. 3GPP and IETF technical specifications (TS), standards (including proposed standards), technical reports (TR) and other papers are incorporated by reference in their entirety hereby, define the related terms and architecture reference models that follow.

[1] 3GPP TS 38.214: “NR; Physical layer procedures for data”. November 2021

[2] 3GPP Rel-18 work item “Study on Artificial Intelligence (AI)/Machine Learning (ML) for NR Air”

### Acronyms

3GPP: Third generation partnership project
BS: Base Station
CAPEX: Capital Expenditure
COTS: Commercial off-the-shelf
C-plane: Control plane
C-RAN: cloud radio access network
CU: Central unit
DL: downlink
DU: Distribution unit
gNB: gNodeB (applies to NR)
MIMO: multiple input, multiple output
O-DU: O-RAN Distributed Unit
O-RU: O-RAN Radio Unit
O-RAN: Open RAN (Basic O-RAN specifications are prepared by the O-RAN alliance)
OPEX: Operating Expense
RLC: Radio Link Control
RU: Radio Unit
U-plane: User plane
UE: user equipment
UL: uplink
AI: Artificial Intelligence
ML: Machine Learning
CSI: Channel State Information
DCI: Downlink Control Information
RSRP: Reference Signal Receiving Power
SINR: Signal to Interference plus Noise Ratio
PUSCH: Physical Uplink Shared Channel
GCS: Generalized Cosine Similarity
SGCS: Square Generalized Cosine Similarity

### Definitions

Channel: the contiguous frequency range between lower and upper frequency limits.

C-plane: Control Plane: refers specifically to real-time control between O-DU and O-RU, and should not be confused with the UE's control plane

DL: DownLink: data flow towards the radiating antenna (generally on the LLS interface)

LLS: Lower Layer Split: logical interface between O-DU and O-RU when using a lower layer (intra-PHY based) functional split.

O-CU: O-RAN Control Unit-a logical node hosting PDCP, RRC, SDAP and other control functions

O-DU: O-RAN Distributed Unit: a logical node hosting RLC/MAC/High-PHY layers based on a lower layer functional split.

O-RU: O-RAN Radio Unit: a logical node hosting Low-PHY layer and RF processing based on a lower layer functional split. This is similar to 3GPP's “TRP” or “RRH” but more specific in including the Low-PHY layer (FFT/IFFT, PRACH extraction).

OTA: Over the Air

U-Plane: User Plane: refers to IQ sample data transferred between O-DU and O-RU

UL: UpLink: data flow away from the radiating antenna (generally on the LLS interface)

The present disclosure provides embodiments of systems, devices and methods for Radio Access Networks and Cloud Radio Access Networks.

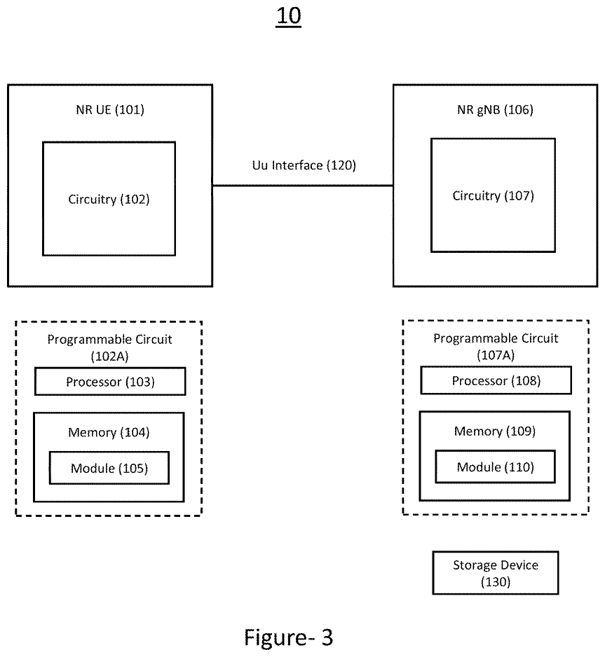

FIG. 3 is a block diagram of a system 100 environment implementing CSI compression and implementing an autoencoder structure via an exchange between a UE and a gNB. System 10 includes a NR UE 101, a NR gNB 106. The NR UE and NR gNB are communicatively coupled via a Uu interface 120.

NR UE 101 includes electronic circuitry, namely circuitry 102, that performs operations on behalf of NR UE 101 to execute methods described herein. Circuity 102 can be implemented with any or all of (a) discrete electronic components, (b) firmware, and (c) a programmable circuit 102A.

NR gNB 106 includes electronic circuitry, namely circuitry 107, that performs operations on behalf of NR gNB 106 to execute methods described herein. Circuity 107 can be implemented with any or all of (a) discrete electronic components, (b) firmware, and (c) a programmable circuit 107A.

Programmable circuit 107A, which is an optional implementation of circuitry 107, includes a processor 108 and a memory 109. Processor 108 is an electronic device configured of logic circuitry that responds to and executes instructions. Memory 109 is a tangible, non-transitory, computer-readable storage device encoded with a computer program. In this regard, memory 109 stores data and instructions, i.e., program code, that are readable and executable by processor 108 for controlling operations of processor 108. Memory 109 can be implemented in a random-access memory (RAM), a hard drive, a read only memory (ROM), or a combination thereof. One of the components of memory 109 is a program module, namely module 110. Module 110 contains instructions for controlling processor 108 to execute operations described herein on behalf of NR gNB 106.

The term “module” is used herein to denote a functional operation that may be embodied either as a stand-alone component or as an integrated configuration of a plurality of subordinate components. Thus, each of module 105 and 110 can be implemented as a single module or as a plurality of modules that operate in cooperation with one another.

While modules 110 are indicated as being already loaded into memories 109, and module 110 can be configured on a storage device 130 for subsequent loading into their memories 109. Storage device 130 is a tangible, non-transitory, computer-readable storage device that stores module 110 thereon. Examples of storage device 130 include (a) a compact disk, (b) a magnetic tape, (c) a read only memory, (d) an optical storage medium, (e) a hard drive, (f) a memory unit consisting of multiple parallel hard drives, (g) a universal serial bus (USB) flash drive, (h) a random-access memory, and (i) an electronic storage device coupled to NR gNB 106 via a data communications network.

Uu Interface 120 is the radio link between the NR UE and NR gNB, which is compliant to the 5G NR specification.

The 3GPP Rel-18 work item “Study on Artificial Intelligence (AI)/Machine Learning (ML) for NR Air” [2] shows the benefits of supporting AI/ML algorithms for enhancing performance and/or reducing complexity/overhead. Enhanced performance depends on use cases, and can include, for example, improved throughput, robustness, accuracy or reliability, and so on. A set of use cases includes: CSI feedback enhancement, beam management, and positioning accuracy enhancement. Described are three implementations of CSI enhancements:
1. A priority rule between legacy CSI and AI/ML-based CSI;
2. An AI/ML-based CSI fallback to legacy CSI reporting; and
3. CSI Prediction.

### 1. a Priority Rule Between Legacy CSI and AI/ML-Based CSI

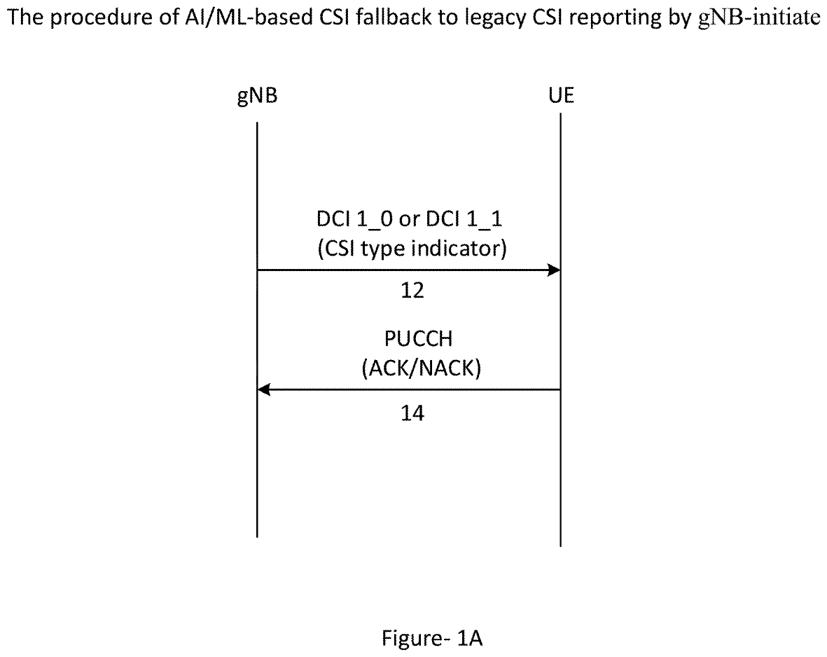

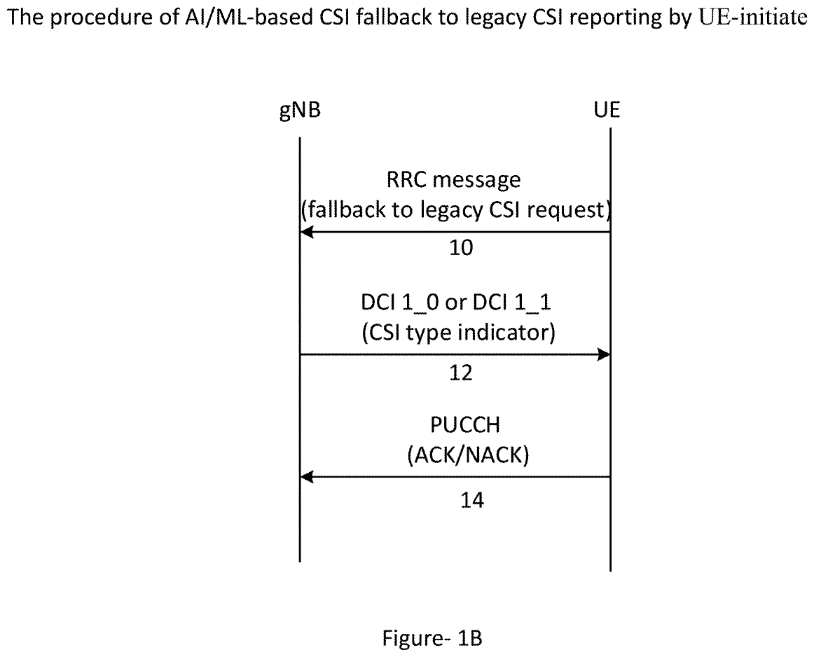

FIG. 1A shows a system flow for a procedure for AI/ML-based CSI fallback compression and prediction for a legacy CSI by gNB-initiate. At block 10, gNB 106 sends the “CSI type indicator” by DCI 1_0 or DCI 1_1 to UE. Then, at block 12, the UE 101 sends an ACK or NACK to gNB.

In current 3GPP 38.214 [1], CSI reports are associated with a priority value Pri_{iCSI}(y, k, c, s)=2·N_{cells}·Mₛ·y+N_{cells}·Mₛ·k+Mₛ·c+s where
y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH;
k=0 for CSI reports carrying L1-RSRP or L1-SINR and k=1 for CSI reports not carrying L1-RSRP or L1-SINR;
c is the serving cell index and N_{cells} is the value of the higher layer parameter maxNrofServingCells;
s is the reportConfigID and Mₛ is the value of the higher layer parameter maxNrofCSI-ReportConfigurations.

Due to the introduction of AI/ML-based CSI compression (and prediction), implementations as described herein are configured to support the priority rule about the collision between legacy CSI and AI/ML-based CSI compression and prediction. The performance of AI/ML-based CSI compression and prediction is better than legacy CSI according to the evaluation, so the priority of AI/ML-based CSI compression (and prediction) can be higher than legacy CSI. New CSI reports associated with a priority value can be generated as follows: Pri_{iCSI}(y, k, c, s)=2·N_{cells}·Mₛ·y+N_{cells}·Mₛ·k+Mₛ·C+s where
y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH;
k=0 for AI/ML-based CSI compression (and prediction) reports carrying L1-RSRP or L1-SINR; k=1 for AI/ML-based CSI compression (and prediction) reports not carrying L1-RSRP or L1-SINR; k=2 for legacy CSI reports carrying L1-RSRP or L1-SINR and k=3 for legacy CSI reports not carrying L1-RSRP or L1-SINR;
c is the serving cell index and N_{cells} is the value of the higher layer parameter maxNrofServingCells; and
s is the reportConfigID and Mₛ is the value of the higher layer parameter maxNrofCSI-ReportConfigurations.

### 2. AI/ML-Based CSI Fallback to Legacy CSI Reporting

The procedure of AI/ML-based CSI compression and prediction fallback to legacy CSI reporting is given. The procedure can be gNB-106 initiate or UE 101-initiate.

In an implementation, as again shown in FIG. 1A, the gNB-106 initiate, the procedure includes two steps. At block 12, gNB 106 sends the “CSI type indicator” by DCI 1_0 or DCI 1_1, and the indicator is shown in Table 1, value 1 means UE reporting AI/ML-based CSI and value 0 means UE reporting legacy CSI. At block 14, when the UE 101 receives the indicator, it sends an ACK/NACK to gNB 106 by PUCCH.

TABLE 1
CSI type indicator

| Value of CSI type indicator | CSI type |
|---|---|
| 1 | AI/ML-based CSI |
| 0 | Legacy CSI |

FIG. 1B shows the procedure of AI/ML-based CSI fallback compression (and prediction) to legacy CSI by UE-initiate. First, at block 10, the UE 101 sends a fallback to CSI legacy request (e.g.: “fallbacktolegacyCSIorprecdictedCSI request”) by RRC message. At block 12, then gNB 106 sends the “CSI type indicator” by DCI 1_0 or DCI 1_1 to UE. At block 14, the UE 101 sends an ACK or NACK to gNB 106.

At block 10, the fallback to CSI legacy request message (fallbacktolegacyCSIorprecdictedCSI request) is used for the indication of UE fallback to legacy CSI request to network. The message can include signaling radio bearer: SRB1, RLC-SAP: AM, and Logic channel: DCCH. In an implementation, the Direction: UE 101 to network is given as follows:

| fallbacktolegacyCSIorprecdictedCSI :: = SEQUENCE { | |
|---|---|
| criticalExtensions | SEQUENCE { |
| fallback to legacy CSI | CHOICE {yes, no} |
| predicted CSI | CHOICE {yes, no} |
| } | |
| } | |

When meeting certain conditions, UE 101 sends the “fallback to legacy CSI” as “yes”, if otherwise as “no”.

For an example, the system can be configured to fallback to legacy CSI (“yes”) when an AI model needs more training time. This can occur when the AI needs validation, or a test module from AI model (including the CSI generation part and CSI construction part model) fails several times continuously. When as a result the UE 101 cannot report AI/ML-based CSI in time, then UE 101 needs to fallback to legacy CSI reporting. In an implementation, a process for sending a fallback to legacy CSI can include:

| | |
|---|---|
| 1> | If AI/ML-based CSI failure indication has been received from the |
| | monitor module: |
| 2> | Start the restart the AI/ML-basedCSIfailureTimer; |
| 2> | Increment the Al/ML-basedCSIfailure_COUNTER by 1; |
| 2> | If the Al/ML-basedCSIfailure_COUNTER ≥ AI/ML- |
| | basedCSIfailure_MaxCount: |
| 3> | Fallback to legacy CSI. |
| 1> | If Al/ML-basedCSIfailureTimer expires; or |
| 1> | If Al/ML-basedCSIfailureTimer, AI/ML-basedCSIfailure_ |
| | MaxCount is reconfigured by upper layers or fallback to legacy |
| | CSI is successfully completed: |
| 2> | Set Al/ML-basedCSIfailure_COUNTER = 0. |

And when meeting the following condition, the monitor module sends the AI/ML-based CSI failure indication: GCS/SGCS between legacy CSI and AI/ML-based CSI is lower than the threshold.

As noted above, based on the fallback to CSI request, at block 12, then gNB 106 sends the “CSI type indicator” by DCI 1_0 or DCI 1_1 to UE. At block 14, the UE 101 sends an ACK or NACK to gNB 106. For the procedure of gNB-106 initiate and UE-101 initiate, if gNB 106 does not send the CSI type indicator to UE 101 or UE 101 does not receive the CSI type indicator, the default is legacy CSI.

### 3. CSI Prediction

In an implementation, a CSI prediction procedure can be sent instead of legacy CSI-RS measurement. The CSI prediction procedure can be a gNB-106 initiate procedure or an UE-101 initiate procedure.

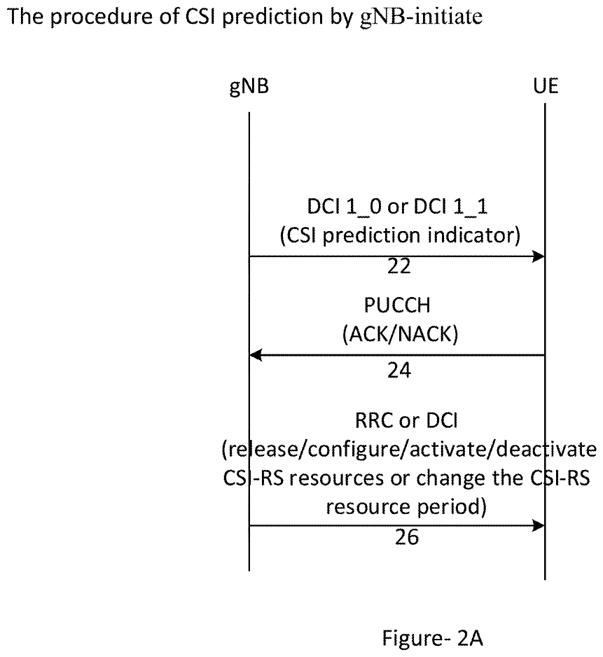

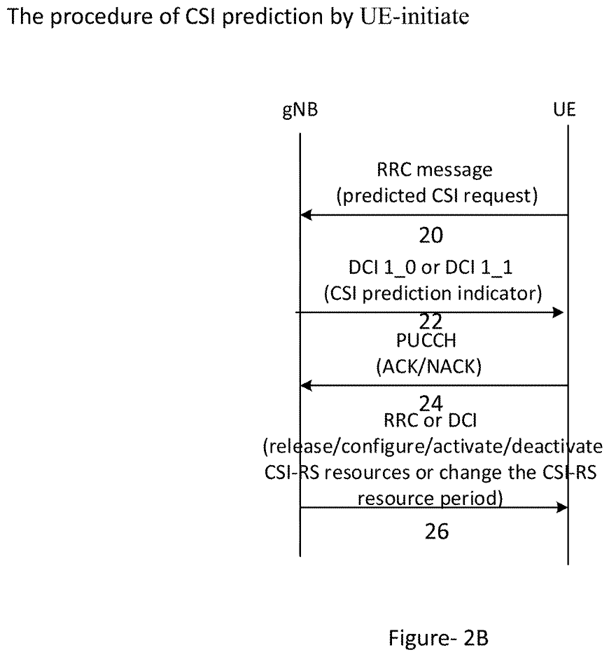

FIG. 2A shows the procedure of CSI prediction by gNB-initiate. At block 22, gNB 106 sends a “CSI prediction indicator” by DCI 1_0 or DCI 1_1 to UE 101. Then, at block 24, UE 101 sends an ACK or NACK to gNB. At block 26, gNB 106 reconfigures the CSI-RS resources by RRC or activates/deactivates by DCI message.

For the gNB-initiate, at block 22 gNB 106 sends the “CSI prediction indicator” and the “the number of collected CSI” by DCI 1_0 or DCI 1_1. The “CSI prediction indicator” is shown in Table 3, where value 1 means UE 101 reporting predicted CSI and value 0 means UE 101 reporting non-predicted CSI, e.g.: the CSI is obtained by measurement of CSI-RS. The “the number of collected CSI” is shown in Table 4, for example, value 0 means collect 0 CSI and value 1 means collect 1 CSI and so on.

When UE 101 receives the indicator as “1”, it starts to collect CSI as input for the AI model. If UE 101 collects enough CSI and can predict CSI by AI model, at block 24, the UE 101 sends an ACK to gNB by PUCCH; otherwise, it sends a NACK to gNB by PUCCH. When UE 101 receives the indicator as “0”, the UE 101 releases the collected CSI for AI model if it has. After completion, at block 24 it sends an ACK to gNB by PUCCH, otherwise, it sends a NACK to gNB by PUCCH.

When gNB 106 receives the ACK and “CSI prediction indicator” is 1, at block 26, gNB 106 can reconfigure the CSI-RS resources including releasing the CSI-RS resources, increasing the CSI-RS resource period, or deactivating the CSI-RS resource to reduce DL overhead. For example, if CSI-RS is periodic, then gNB 106 can be configured to
release CSI-RS resources by RRC message, or
increase the CSI-RS resources period by RRC message.
   If CSI-RS is aperiodic or semi-persistent, then gNB 106 can be configured to
deactivate CSI-RS resources by DCI message, or
increase the CSI-RS resources period by RRC message.

When gNB receives the ACK and “CSI prediction indicator” is 0, at block 26, gNB 106 can configure the CSI-RS resources to measure CSI without CSI prediction function.

For example, if CSI-RS is periodic, then gNB 106 can be configured to:
if CSI-RS is not configured and needs to, configure periodic CSI-RS resources by RRC message as legacy, or
if CSI-RS has been configured and needs to, decrease the CSI-RS resources period by RRC message.

If CSI-RS is aperiodic or semi-persistent, then gNB 106 can be configured to
if CSI-RS has not been activated and needs to, activate CSI-RS resources by DCI message, or
if CSI-RS has been activated and needs to, decrease the CSI-RS resources period by RRC message.

TABLE 3
CSI prediction indicator

| Value of CSI prediction indicator | CSI prediction type |
|---|---|
| 1 | predicted CSI |
| 0 | non-predicted CSI |

TABLE 4
the number of collected CSI

| | the number of |
|---|---|
| Index | collected CSI |
| 0 | 0 |
| 1 | 1 |
| 2 | 2 |
| 3 | 4 |
| . . . | . . . |

FIG. 2B shows the procedure of CSI prediction by a UE initiate process. First, at block 20, UE 101 sends a request to fallback to legacy CSI or use predicted CSI (“fallbacktolegacyCSIorpredictedCSI request”) by RRC message. At block 22, gNB 106 sends the “CSI prediction indicator” by DCI 1_0 or DCI 1_1 to UE 101. At block 24, UE 101 sends an ACK or NACK to gNB 106. At block 26, the gNB 106 reconfigures the CSI-RS resources by RRC or activate/deactivate by DCI message.

For the UE-initiate, the procedure, at block 20 the UE 101 sends the request fallback to legacy CSI or use predicted CSI (“fallbacktolegacyCSIorprecdictedCSI request”) by RRC message, for example, when meeting the following conditions, UE sends the “predicted CSI” as “yes”: UE speed is greater than a threshold, or UE SINR/RSRP/RSRQ is worse than a threshold, such as UE is in the cell edge. Otherwise, the UE 101 sends the “predicted CSI” as “no”. Then, for blocks 22, 24 and 26, the process is the same as the gNB 106 initiate procedure shown in FIG. 2A. If at block 22, gNB 106 does not send the CSI prediction indicator to UE 101 or UE 101 does not receive the CSI prediction indicator, the default is non-predicted CSI.

It will be understood that implementations and embodiments can be implemented by computer program instructions. These program instructions can be provided to a processor to produce a machine, such that the instructions, which execute on the processor, create means for implementing the actions specified herein. The computer program instructions can be executed by a processor to cause a series of operational steps to be performed by the processor to produce a computer-implemented process such that the instructions, which execute on the processor to provide steps for implementing the actions specified. Moreover, some of the steps can also be performed across more than one processor, such as might arise in a multi-processor computer system or even a group of multiple computer systems. In addition, one or more blocks or combinations of blocks in the flowchart illustration can also be performed concurrently with other blocks or combinations of blocks, or even in a different sequence than illustrated without departing from the scope or spirit of the present disclosure.

1. A method comprising:
configuring a priority rule between a legacy CSI module and an AI/ML CSI based module, wherein the AI/ML CSI module is higher than legacy CSI; and
for AI/ML-based CSI module, the AI/ML-based CSI module carrying L1-RSRP or L1-SINR has a higher priority than the AI/ML-based CSI module not carrying L1-RSRP or L1-SINR.

2. The method of claim 1, comprising:
for kin Pri_{iCSI}(y, k, c, s)=2·N_{cells}·Mₛ·y+N_{cells}·Mₛ·k+Mₛ·c+s:
wherein
k=0 for AI/ML-based CSI compression module reports carrying L1-RSRP or L1-SINR;
k=1 for AI/ML-based CSI module reports not carrying L1-RSRP or L1-SINR;
k=2 for legacy CSI module reports carrying L1-RSRP or L1-SINR; and
k=3 for legacy CSI module reports not carrying L1-RSRP or L1-SINR.

3. A method comprising:
sending, by a gNB, a CSI type indicator by DCI 1_0 or DCI 1_1, where a value 1 means UE reporting a AI/ML-based CSI type compression and/or prediction and a value 0 means UE reporting legacy CSI; and
when a UE receives the indicator, the UE sends an ACK/NACK to gNB by PUCCH.

4. The method of claim 3, further comprising:
sending, by the UE, a fallback to legacy CSI Request by RRC message, wherein the fallback to legacy CSI Request is used for the indication of the UE fallback to a legacy CSI request to network.

5. The method of claim 4, wherein the UE is configured to send the fallback to legacy CSI Request as a yes when an AI model needs more training time.

6. The method of claim 5, further comprising:
when AI/ML-based CSI failure indication has been received from a monitor module:
start the restart an AI/ML based CSI failure timer; and
increment an AI/ML based CSI failure counter by 1; or
when the AI/ML based CSI failure counter is equal to or greater than a AI/ML based CSI failure maximum count,
fallback to legacy CSI; or
when the AI/ML based CSI failure timer expires; or
when the AI/ML based CSI failure timer or the AI/ML based CSI failure counter maximum count is reconfigured by an upper layer, or a fallback to legacy CSI is successfully completed,
set the AI/ML based CSI failure counter to 0.

7. The method of claim 6, further comprising:
sending, by the monitor module, the AI/ML-based CSI failure indication when GCS/SGCS between legacy CSI and AI/ML-based CSI is lower than the threshold.

8. The method of claim 6, further comprising: the CSI type indicator value 1 meaning a UE reporting AI/ML-based CSI and a value 0 means UE reporting legacy CSI.

9. The method of claim 3, further comprising:
defaulting to legacy CSI when the gNB does not send the CSI type indicator to UE or UE does not receive the CSI type indicator.

10. The method of claim 3, further comprising
sending by a gNB, a CSI prediction indicator value as the CSI type indicator value and a number of collected CSI value, wherein when the UE collects enough CSI and can predict CSI by AI model, it sends an ACK to gNB otherwise, it sends the NACK to gNB; and
receiving, by the gNB, the ACK and CSI prediction indicator value, wherein when the CSI prediction indicator value is 1, the gNB reconfigures the CSI-RS resources including releasing the CSI-RS resources, increasing the CSI-RS resource period, or deactivating the CSI-RS resource to reduce DL overhead; and when gNB receives the ACK and CSI prediction indicator value is 0, the gNB configures the CSI-RS resources to measure CSI without CSI prediction function.

11. The method of claim 10, further comprising:
sending by a UE sends, a fallback to legacy CSI or predicted CSI request by RRC message; and when:
the UE sends a predicted CSI as a yes or as a no,
a UE speed is greater than a threshold, or
a UE SINR/RSRP/RSRQ is lower than the threshold,
sending by a gNB, a CSI prediction indicator and the number of collected CSI by DCI 1_0 or DCI 1_1.

12. The method of claim 11, wherein
the CSI prediction indicator value 1 means UE reporting predicted CSI, and
the CSI prediction indicator value 0 means UE reporting non-predicted CSI,
wherein the CSI is obtained by measurement of CSI-RS.

13. The method of claim 12, further comprising:
sending, by the UE the CSI prediction request as 1; or
sending, by the UE, CSI prediction request as 0 when the UE speed is greater than a threshold, or a UE SINR/RSRP/RSRQ is lower than the threshold.

14. The method of claim 10, further comprising:
defaulting to legacy CSI when the gNB does not send the CSI type indicator to UE or the UE does not receive the CSI type indicator.

15. The method of claim 10, further comprising:
sending by a gNB, the number of collected CSI value, wherein, starting with the number of collected CSI value n=0, the number of collected CSI value n means collect n+1 CSI, and when UE receives the CSI prediction indicator as “1”, the UE starts to collect CSI as input for AI model; and
when UE receives the indicator as “0”, the UE releases the collected CSI for AI model, and after completion, it sends the ACK to gNB.

16. The method of claim 15, further comprising;
when the CSI-RS is periodic, then the gNB
releases CSI-RS resources by RRC message, or
increases the CSI-RS resources period by RRC message and when CSI-RS is aperiodic or semi-persistent, then the gNB
deactivates CSI-RS resources by DCI message, or
increases the CSI-RS resources period by RRC message.

17. A system comprising:
a gNB configured to send a CSI type indicator by DCI 1_0 or DCI 1_1, where a value 1 means UE reporting a AI/ML-based CSI type compression and/or prediction and a value 0 means UE reporting legacy CSI; and
a UE configured to, when the UE receives CSI type indicator, sends an ACK/NACK to gNB by PUCCH.

18. The system of claim 17, wherein the UE is configured to send a fallback to legacy CSI Request by RRC message, and wherein the fallback to legacy CSI Request is used for the indication of the UE fallback to a legacy CSI request to network.

19. The system of claim 18, further comprising:
the UE being configured to send the fallback to legacy CSI or a predicted CSI request by RRC message; and when:
the predicted CSI is sent as a yes or as a no,
a UE speed is greater than a threshold, or
a UE SINR/RSRP/RSRQ is lower than the threshold,
the gNB being configured to a CSI prediction indicator and the number of collected CSI by DCI 1_0 or DCI 1_1.

20. The system of claim 17, wherein
the CSI type indicator value 1 means UE reporting predicted CSI; and
the CSI type indicator value 0 means UE reporting non-predicted CSI,
wherein the CSI is obtained by measurement of CSI-RS.
